(19) United States
(12) Patent Application Publication
(10) Pub. No.: US 2022/0152944 A1
(43) Pub. Date: May 19, 2022

(54) EMBOSSED VACUUM BAG FILM, VACUUM BAGGING SYSTEM INCLUDING AN EMBOSSED VACUUM BAG FILM, AND METHODS OF FABRICATING A COMPOSITE PART USING THE SAME

(71) Applicant: Airtech International, Inc., Huntington Beach, CA (US)

(72) Inventors: Jeffrey L. Dahlgren, Brentwood, TN (US); Philip A. Lunn, Warwick (GB); Zachary I. Skelton, Laguna Hills, CA (US)

(21) Appl. No.: 17/098,153

(22) Filed: Nov. 13, 2020

(51) Int. Cl. B29C 70/34; B32B 27/08; B32B 27/34; B32B 27/32; B32B 3/26; B29C 70/54

(52) U.S. Cl. CPC B29C 70/342; B32B 27/08; B32B 27/34; B32B 2439/46; B32B 3/263; B29C 70/54; B32B 27/32

(57) ABSTRACT

An embossed vacuum bag film for use in a vacuum bagging system during a process of curing a composite part. The embossed vacuum bag film includes a raised pattern defining a lower air pathway. The embossed vacuum bag film may be a single layer or a multi-layer film including an upper layer having low permeability and a lower layer coupled to the upper layer that is configured to self-release from the composite part.

### FIELD

Aspects of the present disclosure relate generally to an embossed vacuum bag film for use in a vacuum bagging process during the fabrication of a composite part.

### BACKGROUND

Advanced composite parts typically include layers of fibrous materials bonded together with a matrix of polymer (i.e., a resin). Fabrication of composite parts typically includes laying up fibers on a mold. The lay-up process may be performed either by manually laying up prepreg fabric (i.e., fibrous materials that are pre-impregnated with the matrix material) or the lay-up process may be performed automatically using an automated tape layup (ATL) or an automated fiber placement (AFP) process. When a one-sided mold is utilized, conventional fabrication techniques utilize a vacuum bagging system to press the fibrous layers onto the mold, remove trapped air between the layers, and achieve the desired fiber-to-resin ratio such that the composite part exhibits the desired laminate properties (e.g., strength, weight, and stiffness).

Conventional vacuum bagging systems typically include a peel ply on the layers that are to be consolidated into the composite part, a release film on the peel ply, a breather/bleeder fabric on the release film, and a vacuum bag film on the breather/bleeder fabric that is sealed along its edges to the mold with sealant tape. The peel ply may be omitted in some instances. Conventional vacuum bagging systems also includes a vacuum pump connected to a port in the vacuum bag that is configured to withdraw the air out of the interior space between the vacuum bag film and the mold. The breather/bleeder fabric is a relatively thick non-woven fabric configured to provide an escape path for air being withdrawn from the interior space. The breather/bleeder fabric is also configured to absorb any excess resin that bleeds out the fibrous layers as they are compressed by the vacuum bag film. The release film is included to allow the bagging materials to be removed after cure from the fabricated composite component.

The cure of the resin can take place in an oven with vacuum bag pressure only.

Alternatively, the resin can be cured at an elevated temperature and elevated pressure in an autoclave to achieve a higher degree of consolidation of the fibrous layers. The cure may also occur via a catalyst, either with or without the application of an elevated temperature.

The numerous layers of these conventional vacuum bagging systems increases the manufacturing cost, cycle time, and waste associated with fabricating composite parts.

### SUMMARY

The present disclosure relates to various embodiments of an embossed vacuum bag film for use in a vacuum bagging system during a process of curing a composite part. In one embodiment, the embossed vacuum bag film includes a raised pattern defining a lower air pathway. The embossed vacuum bag film may be a single layer having low permeability and configured to self-release from the composite part. The single layer embossed vacuum bag film may include polyamides, polyolefins, fluoropolymers, combinations thereof, and alloys thereof. A release-coating may be on at least a portion of an inner surface of the embossed vacuum bag film. Alternatively, the embossed vacuum bag film may be a multi-layer film including an upper layer (having low permeability) and a lower layer (configured to self-release from the composite part) coupled to the upper layer. The upper layer may be a polyamide film, and the lower layer may include a polyolefin or a fluoropolymer material. The upper layer and the lower layer may be co-extruded or laminated together.

The present disclosure also relates to various embodiments of a vacuum bagging system for use during a process of curing a composite part. In one embodiment, the vacuum bagging system includes an embossed vacuum bag film including a raised pattern defining a lower air pathway, a tape sealant configured to seal the embossed vacuum bag to a mold, a valve in communication with an interior space between the embossed vacuum bag film and the mold, and a hose coupled to the valve. The embossed vacuum bag film may be a single layer having low permeability and configured to self-release from the composite part. The single layer embossed vacuum bag film may include polyamides, polyolefins, fluoropolymers, combinations thereof, and alloys thereof. A release-coating may be on at least a portion of an inner surface of the embossed vacuum bag film. Alternatively, the embossed vacuum bag film may be a multi-layer film including an upper layer (having low permeability) and a lower layer (configured to self-release from the composite part) coupled to the upper layer. The upper layer may be a polyamide film, and the lower layer may include a polyolefin or a fluoropolymer material. In some embodiments, the material of the embossed vacuum bag film (e.g., the material of the lower layer if the embossed vacuum bag film has a multi-layer construction, or the material of the entire embossed vacuum bag film if the embossed vacuum bag film is a single layer) is configured to self-release from the cured composite part, and therefore the embossed vacuum bag film negates the need for a separate release film that is included in a conventional vacuum bagging system. Additionally, in some embodiments, the raised pattern defining the lower air pathway negates the need for a breather fabric that is included in conventional vacuum bagging systems. Accordingly, in one embodiment, the vacuum bagging system does not include a breather fabric or a release film separate from the embossed vacuum bag film, which simplifies the vacuum bagging system, satisfies lean manufacturing principles, and reduces cycle time, manufacturing cost, and waste.

The present disclosure is also directed to various methods of fabricating a composite part. In one embodiment, the method includes loading fibrous material of an uncured composite part on a mold, and curing the uncured composite part to form the composite part. Curing the uncured composite part includes placing the uncured composite part in a vacuum bagging system and placing the vacuum bagging system and the uncured composite part in an oven or an autoclave. Placing the uncured composite part in the vacuum bagging system includes covering the fibrous material with an embossed vacuum bag film and sealing the embossed vacuum bag film to the mold. The embossed vacuum bag film includes a raised pattern defining a lower air pathway. The method also includes evacuating air from an interior space between the vacuum bag film and the mold utilizing a vacuum pump of the vacuum bagging system. During the task of evacuating the air from the interior space, air flows through the lower air pathway defined by the embossed vacuum bag film. Additionally, the vacuum bagging system utilized during the task of curing the composite part does not include a breather fabric or a release film separate from the embossed vacuum bag film, which simplifies the vacuum bagging system, satisfies lean manufacturing principles, and reduces cycle time, manufacturing cost, and waste.

The method also includes removing the composite part from the vacuum bagging system. The embossed vacuum bag film is configured to self-release from the composite part during the task of removing the composite part from the vacuum bagging system.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable embossed vacuum bag film, a vacuum bagging system, or a method of fabricating a composite part.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a cross-sectional view of a vacuum bagging system including a self-releasing embossed vacuum bag film according to one embodiment of the present disclosure; and

FIG. 2 is a flowchart illustrating tasks of a method of fabricating a composite part according to one embodiment of the present disclosure.

### DETAILED DESCRIPTION

The present disclosure is directed to various embodiments of an embossed vacuum bag film, a vacuum bagging system including an embossed vacuum bag film for use in curing composite parts, and various methods of fabricating a composite part using a vacuum bagging system including an embossed vacuum bag film during a task of curing the composite part. The embossed vacuum bag film includes a raised pattern defining a lower air pathway configured to facilitate the removal of the air inside the interior of the vacuum bag during a vacuum sealing operation, which mitigates against the formation of defects in the fabricated composite part. Accordingly, in some embodiments, the embossed vacuum bag film negates the need for a breather fabric that is included in conventional vacuum bagging systems. Additionally, in some embodiments, the embossed vacuum bag film includes a multi-layer construction including a low permeability outer layer and a self-releasing polymer inner layer. The multi-layer construction of the embossed vacuum bag film negates the need for a separate release film that is typically included in a conventional bag sealing system (i.e., the multi-layer embossed vacuum bag film is configured to performed the function of both a release film and a vacuum bag film included in conventional vacuum bagging systems). In other embodiments, the embossed vacuum bag film may have a mono-layer construction (i.e., a single (monolithic) layer) formed of, for example, a blended polymer or a co-polymer configured to perform the function of both a release film and a vacuum bag film included in conventional vacuum bagging systems. A release-coating may be applied to at least a portion of an inner surface of the embossed vacuum bag film. Accordingly, in some embodiments, the construction of the embossed vacuum bag film negates the need for a breather fabric and a separate release film that are typically included in a conventional vacuum bagging system, which simplifies the vacuum bagging system and the method of vacuum sealing with the vacuum bagging system, satisfies lean manufacturing principles, and reduces cycle time, manufacturing cost, and waste.

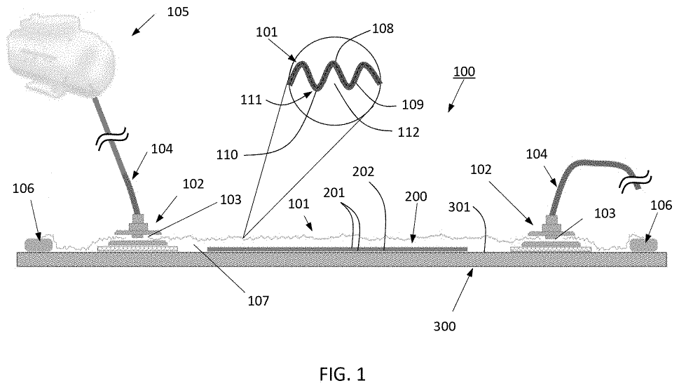

FIG. 1 depicts a vacuum bagging system 100 according to one embodiment of the present disclosure for use in fabricating a composite part 200 on a mold surface 301 of a mold 300. Although in the illustrated embodiment the mold surface 301 is flat (e.g., planar), in one or more embodiments the mold surface 301 may have any shape depending on the desired shape of the composite part 200. For instance, in one or more embodiments, the mold surface 301 may have a simple curvature or a compound curvature.

The composite part 200 being fabricated includes fibrous materials 201 (e.g., layers or plies of fabric or fibrous materials) bonded together with a matrix of polymer 202 (e.g., a resin material) and arranged in a laminate stack. Suitable fibrous materials include, but are not limited to, carbon, fiberglass, aramid, and quartz. Suitable matrix materials include, but are not limited to, epoxy, polyester, vinyl esters, bismaleimids (BMI), and/or benzoxazine. The fibrous material 201 may be pre-impregnated with the matrix material 202 in the form of a prepreg fabric that can be manually placed on the mold surface 301 of the mold 300 or in the form of tape or tow that can be placed on the mold surface 301 of the mold 300 automatically with a machine. During the process of fabricating the composite part 200, the fibrous materials 201 are pressed together such that the composite part 200 achieves the form of the mold surface 301 of the mold 300 and the composite part 200 has the desired fiber-to-matrix ratio and the desired laminate properties of the composite part 200 (e.g., strength, weight, and/or stiffness).

In the illustrated embodiment, the vacuum bagging system 100 includes an embossed vacuum bag film 101, one or more vacuum valves 102 received in one or more openings or ports 103 in the embossed vacuum bag film 101, one or more vacuum hoses 104 connected to the one or more vacuum valves 102, a vacuum pump 105 connected to the one or more vacuum hoses 104, and a sealant 106 (e.g., a vacuum sealant tape) sealing the embossed vacuum bag film 101 to the mold 300. Although in the illustrated embodiment the one or more vacuum ports 103 and the one or more vacuum valves 102 are provided in the embossed vacuum bag film 101, in one or more embodiments, the one or more vacuum ports 103 and the one or more vacuum valves 102 may be provided in the mold 300. The vacuum bagging system 100 may include a single embossed vacuum bag film 101 or the vacuum bagging system 100 may include two or more embossed vacuum bag films 101 the edges of which overlap each other and are sealed together with sealant tape (e.g., the vacuum bagging system 100 may include a single embossed vacuum bag film 101 or multiple embossed vacuum bag films 101 with overlapping sealant tape joints). The embossed vacuum bag film 101 covers an upper surface of the composite part 200 being fabricated, and together the embossed vacuum bag film 101, the sealant 106, and the mold 300 define an interior chamber 107 in which the composite part 200 being fabricated is accommodated. The one or more vacuum hoses 104 and the one or more vacuum valves 102 are in fluid communication with the interior chamber 107 and are configured to withdraw the air from the interior chamber 107. Additionally, in the illustrated embodiment, the vacuum bagging system 100 does not include a breather fabric or a separate release film (e.g., the embossed vacuum bag film 101 negates the need for a breather fabric and a separate release film that are included in a conventional vacuum bagging system). Eliminating the breather fabric and the release film simplifies the vacuum bagging system 100, satisfies lean manufacturing principles, and reduces cycle time, manufacturing cost, and waste.

In the illustrated embodiment, the embossed vacuum bag film 101 has a multi-layer construction including at least an outer layer 108 (i.e., a layer 108 facing away from the composite part 200 being fabricated) and an inner layer 109 (i.e., a layer 109 facing toward the composite part 200 being fabricated). During a task of curing the uncured composite part 200 using the vacuum bagging system 100, an inner surface of the inner layer 109 of the embossed vacuum bag film 101 contacts an upper surface of the uncured composite part 200. In one or more embodiments, the outer layer 108 may be in direct contact with the inner layer 109. In one or more embodiments, the embossed vacuum bag film 101 may include one or more intermediate layers between the outer and inner layers 108, 109. The outer layer 108 of the embossed vacuum bag film 101 may be constructed of any material having very low permeability to provide high vacuum integrity in high pressure autoclave environments, and which the sealant 106 can effectively adhere to. In one embodiment, the outer layer 108 may be a polyamide film (e.g., a film selected from a family of synthetic polymers based on aliphatic or semi-aromatic polyamides). Suitable polyamides for the outer layer 108 of the embossed vacuum bag film 101 include polyamide 6; polyamide 12; polyamide 6,6; polyamide 6,10; polyamide 6, 12; polyamide 4, 6; combinations thereof (at varying percentages of the polyamides); or alloys thereof (at varying percentages of the polyamides) (e.g., the outer layer 108 of the embossed vacuum bag film 101 may include a blended polymer). Additionally, in one or more embodiments, the polyamide(s) of the outer layer 108 of the embossed vacuum bag film 101 may be combined with one or more colorants and/or additives. The inner layer 109 of the embossed vacuum bag film 101, which is configured to contact the upper surface of the uncured composite part 200, may be formed of any suitable material or materials such that the embossed vacuum bag film 101 is configured to self-release from the composite part 200 after it has been fabricated using the vacuum bagging system 100. For instance, in one or more embodiments, the inner layer 109 may be formed of any suitable polymer, such as a polyolefin and/or a fluoropolymer material. Suitable polyolefins for the inner layer 109 of the embossed vacuum bag film 101 include polymethyl pentene, polypropylene, polyethylene, or combinations or alloys thereof. Suitable fluoropolymers for the inner layer 109 of the embossed vacuum bag film 101 include PTFE (polytetrafluoroethylene), PFA (perfluoroalkoxy polymer), FEP (fluorinated ethylene-propylene), ETFE (polyethylenetetrafluoroethylene) or combinations or alloys thereof. Additionally, in one or more embodiments, the polyolefins and/or the fluoropolymers of the inner layer 109 of the embossed vacuum bag film 101 may be combined with one or more colorants and/or additives. In general, polyamide can release from some resins, but will bond to most, and a polyolefin or fluoropolymer construction will still stick to the sealant tape 106 but will release from most resins. Accordingly, in one or more embodiments, one or more materials of the inner layer 109 of the embossed vacuum bag film 101 may be selected depending on the materials of the composite part 200 (e.g., the material of the fibers 201 and/or the matrix 202). The embossed vacuum bag film 101 may be fabricated in any suitable method, such as by co-extrusion or lamination (e.g., co-extruding the outer and inner layers 108, 109 to form the multi-layer construction, or laminating individual outer and inner layers 108, 109 together to form the multi-layer construction).

In one or more embodiments, the embossed vacuum bag film 101 may not be formed from multiple layers (e.g., the embossed vacuum bag film 101 may be a single (monolithic) layer). The single layer embossed vacuum bag film 101 may have the same or substantially the same characteristics or properties as the multi-layer embossed vacuum bag film 101 described above (e.g., the single layer embossed vacuum bag film 101 may have both very low permeability to provide high vacuum integrity in high pressure autoclave environments and be configured to self-release from the composite part 200 after it has been fabricated using the vacuum bagging system 100). In one or more embodiments, the single layer embossed vacuum bag film 101 may include a polyamide, such as polyamide 6; polyamide 12; polyamide 6,6; polyamide 6,10; polyamide 6,12; polyamide 4,6; combinations thereof (at varying percentages of the polyamides); or alloys thereof (at varying percentages of the polyamides). Accordingly, in one or more embodiments, the single layer embossed vacuum bag film 101 may include a blended polymer. The polyamide(s) of the single layer embossed vacuum bag film 101 may be combined with other polymers to achieve other desired properties, such as release characteristics and/or temperature tolerance of the single layer embossed vacuum bag film 101. For instance, in one or more embodiments, the polyamide(s) may be combined with one or more polyolefins (e.g., polymethyl pentene, polypropylene, and/or polyethylene) and/or one or more fluoropolymers (e.g., PTFE (polytetrafluoroethylene), PFA (perfluoroalkoxy polymer), FEP (fluorinated ethylene-propylene), ETFE (polyethylenetetrafluoroethylene) or combinations or alloys thereof.). Polyethylene has release characteristics at lower temperature, and polymethyl pentene and polypropylene may be used to handle elevated temperatures during the curing process. Additionally, in one or more embodiments, the polyamide(s) of the single layer embossed vacuum bag film 101 may be combined with one or more colorants and/or additives. In one or more embodiments, the single layer embossed vacuum bag film 101 may include one or more polyolefins (e.g., polymethyl pentene, polypropylene, and/or polyethylene) and/or one or more fluoropolymers (e.g., PTFE, PFA, FEP, ETFE, or combinations or alloys thereof) without the inclusion of a polyamide. Furthermore, in one or more embodiments, a release-coating is on at least a portion of an inner surface 110 of the single layer embossed vacuum bag film 101 facing toward the composite part 200. The release-coating may be formed of any suitable material(s) configured to release from the composite part 200 and the material(s) of the release-coating may be selected depending, at least in part, on the composition of the matrix material 202 of the composite part 200.

In the illustrated embodiment, the embossed vacuum bag film 101 also includes a raised pattern 111 projecting outward (e.g., upward) away from the composite part 200 being fabricated and projecting downward toward the composite part 200 being fabricated. The raised pattern 111 of the embossed vacuum bag film 101 defines a lower air pathway 112. When the embossed vacuum bag film 101 is placed on the plies of fibrous materials 201 during a task of forming the composite part 200, the lower air pathway 112 is defined in the interior space 107 between the embossed vacuum bag film 101 and the composite part 200 being fabricated (e.g., the plies of fibrous materials 201). In one or more embodiments, the raised pattern 111 may be formed in a regular, repeating arrangement or in an irregular arrangement (e.g., a random arrangement). Accordingly, in one or more embodiments, the lower air pathway 112 may be uniform across the embossed vacuum bag film 101 or the lower air pathway 112 may vary in size and/or shape across the embossed vacuum bag film 101. During the process of withdrawing the air from the interior chamber 107 with the valves 102, the hoses 104, and the vacuum pump 105, the lower air pathway 112 defined in the embossed vacuum bag film 101 is configured facilitate the removal of the air inside the interior chamber 107. For instance, the one or more embodiments, the lower air pathway 112 is configured to mitigate against the formation of pockets in the embossed vacuum bag film 101 in which trapped air cannot be evacuated (e.g., if pockets or bubbles/rippling form in the embossed vacuum bag film 101 during the process of removing the air from the interior chamber 107, the lower air pathway 112 defined by the raised pattern 111 of the embossed vacuum bag film 101 permits the removal of air trapped inside the pockets or bubbles). In one or more embodiments, the lower air pathway 112 defined by the raised pattern 111 of the embossed vacuum bag film 101 allows for the complete or substantially complete removal of the air and/or volatile materials inside the interior chamber 107. Complete or substantially complete removal of the air and/or the volatile materials from the interior chamber 107 is important to avoiding the formation of defects in the fabricated composite part 200.

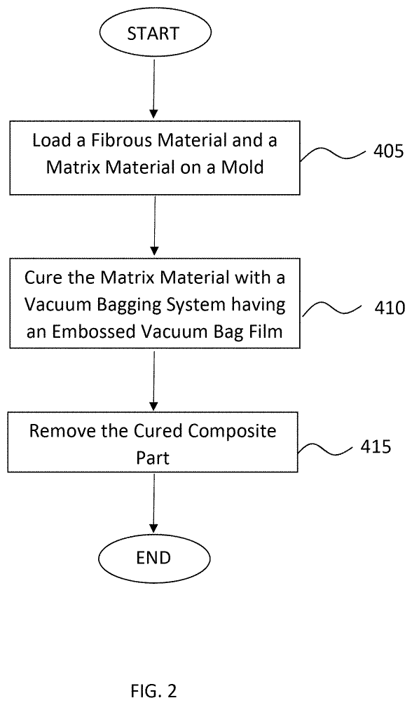

FIG. 2 is a flowchart illustrating tasks of a method 400 of fabricating a composite part utilizing the vacuum bagging system 100 described above according to one embodiment of the present disclosure. In the illustrated embodiment, the method 400 includes a task 405 of loading or placing a fibrous material (e.g., fabric plies) and a matrix material (e.g., a resin) on a mold surface of a mold (e.g., mold 300 shown in FIG. 1) having the desired shape (e.g., planar, simple curvature, or compound curvature) of the composite part. The task 405 of loading the fibrous material and the matrix material on the mold may be performed in any suitable manner known in art or hereinafter developed. In one embodiment, the plies of fibrous materials may be pre-impregnated with the matrix material in the form of a prepreg fabric, and the task 405 may include manually placing the prepreg fabric on the mold (i.e., performing a manual layup of the fibrous layers on the mold). In one or more embodiments, the task 405 may include automatically placing tape or tow (e.g., carbon fiber threads) on the mold utilizing a machine (e.g., the task 405 may include an automated tap layup (ATL) or automated fiber placement (AFP) process). Following the task 405 of placing the plies of fibrous material and the matrix material, the plies are arranged in a laminate stack on the mold.

In the illustrated embodiment, the method 400 also includes a task 410 of curing the matrix material (e.g., the resin) in the fibrous material that were laid up on the mold in task 405. In one or more embodiments, the task 410 of curing the matrix material includes placing the uncured composite part (e.g., the fibrous material bonded together with the resin) inside the vacuum bagging system 100 depicted in FIG. 1. Accordingly, in the illustrated embodiment, the task 410 of curing the matrix material includes covering the fibrous material (which is bonded together with the matrix material) that were placed in task 405 with the embossed vacuum bag film 101 having one or more valves 102 and hoses 104 connected to the one or more openings or ports 103 in the embossed vacuum bag film 101, and sealing the embossed vacuum bag film 101 to the mold with the sealant 106 (e.g., the vacuum sealant tape), as shown for example in FIG. 1. In one embodiment, the task 410 may include covering the fibrous material with a single embossed vacuum bag film 101. In one or more embodiments, the task 410 may include covering the fibrous material with two or more embossed vacuum bag films 101 that are sealed together with sealant tape. In one or more embodiments, the task 410 of curing the composite part utilizing the vacuum bagging system 100 may not include placing a breather layer or a separate release film on the fibrous material (e.g., the embossed vacuum bag film 101 placed in task 410 negates the need for using a breather fabric and a separate release film that are utilized in conventional vacuum bagging processes). Eliminating the breather fabric and the release film simplifies the method 400 of fabricating the composite part, satisfies lean manufacturing principles, and reduces cycle time, manufacturing cost, and waste.

In one or more embodiments, the task 410 of curing the resin may be initiated by a catalyst or hardener additive premixed into the resin, and the curing may occur at room temperature. In one or more embodiments, the task 410 of curing the matrix material includes placing the vacuum bagging system 100 (and the uncured composite part therein) inside an oven generating an elevated temperature, or inside an autoclave generating an elevated temperature and an elevated pressure, and activating the vacuum pump 105 connected to the one or more hoses 104 to withdraw air from the interior chamber 107 of the vacuum bag film 101 in which the fibrous material is positioned. Activating the vacuum pump 105 of the vacuum bagging system 100 during the task 410 of curing the resin holds the composite part in position on the mold, further consolidates the fibrous material, contains the resin where it is required, and withdraws off-gassing from the resin that occurs as the matrix cures. Curing the composite part in an autoclave may result in a greater degree of compaction of the composite part compared to a composite part in which the resin was cured in an oven or at room temperature.

As described above, the embossed vacuum bag film 101 includes a raised pattern 111 defining a lower air pathway 112 between embossed vacuum bag film 101 and the composite part being formed. During the task 410 of curing the composite part, which includes placing the uncured composite part in the vacuum bagging system 100 and activating the vacuum pump 105, air and/or volatile materials generated during off-gassing from the resin flow through the lower air pathway 112 and are removed from the interior chamber 107. For instance, in one or more embodiments, the lower air pathway 112 is configured to mitigate against the formation of pockets in the embossed vacuum bag film 101 in which trapped air and/or volatiles cannot be evacuated (e.g., if pockets or bubbles/rippling form in the embossed vacuum bag film 101 during the task 415 of curing the composite part, the lower air pathway 112 defined by the raised pattern 109 of the embossed vacuum bag film 101 permits the removal of the air and/or volatile materials trapped inside these pockets or bubbles). In one or more embodiments, the lower air pathway 112 defined by the raised pattern 109 of the embossed vacuum bag film 101 allow for the complete or substantially complete removal of the air and/or volatile material inside the interior chamber 107 during the task 415 of curing the composite part. Complete or substantially complete removal of the air and/or volatile material from the interior chamber 107 mitigates against the formation of defects in the fabricated composite part.

In the illustrated embodiment, the method 400 also includes a task 415 of removing the cured composite part from the interior chamber 107 of the vacuum bagging system 100. As described above, the inner layer 109 of the multi-layer embossed vacuum bag film 101 or an inner surface of the single layer embossed vacuum bag film 101, which contacts the upper surface of the composite part, may be formed of any suitable material (e.g., a polymer, such as a polyolefin or a fluoropolymer) such that the embossed vacuum bag film 101 is configured to self-release from the cured composite part after it has been fabricated using the vacuum bagging system 100, which facilitates removal of the composite part in task 415. In one or more embodiments in which the embossed vacuum bag film 101 includes a single layer, the entire embossed vacuum bag film 101 may be formed of a material configured to release from the cured composite part (e.g., the entire embossed vacuum bag film 101 may be formed of a polymer, such as a polyolefin or a fluoropolymer).

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures, methods of manufacture, and methods of application can be practiced without meaningfully departing from the principles, spirit, and scope of this invention.

Additionally, as used herein, the term “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” another layer or structure, it can be directly on the other layer or structure or intervening layer(s) and/or structures(s) may be present therebetween.

The tasks described above may be performed in the order described or in any other suitable sequence. Additionally, the methods described above are not limited to the tasks described. Instead, for each embodiment, one or more of the tasks described above may be absent and/or additional tasks may be performed.

1. An embossed vacuum bag film for use in a vacuum bagging system during a process of curing a composite part, the embossed vacuum bag film comprising a raised pattern defining a lower air pathway.

2. The embossed vacuum bag film of claim 1, wherein the embossed vacuum bag film is a single layer.

3. The embossed vacuum bag film of claim 2, wherein the single layer has low permeability and is configured to self-release from the composite part.

4. The embossed vacuum bag film of claim 3, wherein the single layer comprises a material selected from the group consisting of polyam ides, polyolefins, fluoropolymers, combinations thereof, and alloys thereof.

5. The embossed vacuum bag film of claim 2, further comprising a release-coating on at least a portion of an inner surface of the embossed vacuum bag film.

6. The embossed vacuum bag film of claim 1, wherein the embossed vacuum bag film is a multi-layer film comprising:
an upper layer having low permeability; and
a lower layer coupled to the upper layer, the lower layer being configured to self-release from the composite part.

7. The embossed vacuum bag film of claim 6, wherein the upper layer comprises polyamide film, and wherein the lower layer comprises a polyolefin or a fluoropolymer.

8. The embossed vacuum bag film of claim 6, wherein the upper layer and the lower layer are co-extruded.

9. The embossed vacuum bag film of claim 6, wherein the upper layer and the lower layer are laminated together.

10. A vacuum bagging system for use during a process of curing a composite part, the vacuum bagging system comprising:
an embossed vacuum bag film comprising a raised pattern defining a lower air pathway;
a tape sealant configured to seal the embossed vacuum bag film to a mold;
a valve in communication with an interior space between the embossed vacuum bag film and the mold; and
a hose coupled to the valve,
wherein the vacuum bagging system does not include a breather fabric, and
wherein the vacuum bagging system does not include a release film separate from the embossed vacuum bag film.

11. The vacuum bagging system of claim 10, wherein the embossed vacuum bag film is a single layer.

12. The vacuum bagging system of claim 11, wherein the single layer has low permeability and is configured to self-release from the composite part.

13. The vacuum bagging system of claim 12, wherein the single layer comprises a material selected from the group consisting of polyamides, polyolefins, fluoropolymers, combinations thereof, and alloys thereof.

14. The vacuum bagging system of claim 11, further comprising a release-coating on at least a portion of an inner surface of the embossed vacuum bag film.

15. The vacuum bagging system of claim 10, wherein the embossed vacuum bag film comprises:
an upper layer having low permeability; and
a lower layer coupled to the upper layer, the lower layer being configured to self-release from the composite part.

16. The vacuum bagging system of claim 15, wherein the upper layer comprises polyamide film, and wherein the lower layer comprises a polyolefin or a fluoropolymer.

17. A method of fabricating a composite part, the method comprising:
loading a fibrous material of an uncured composite part on a mold;
curing the uncured composite part to form the composite part, wherein the curing the uncured composite part comprises placing the uncured composite part in the vacuum bagging system of claim 10 and placing the vacuum bagging system and the uncured composite part in an oven or an autoclave,
wherein the placing the uncured composite part in the vacuum bagging system comprises:
covering the plurality of fabric layers with the embossed vacuum bag film comprising the raised pattern defining the lower air pathway; and
sealing the embossed vacuum bag film to the mold with the tape sealant; and
evacuating air from the interior space between the embossed vacuum bag film and the mold utilizing a vacuum pump of the vacuum bagging system coupled to the hose, wherein air flows through the lower air pathway defined by the embossed vacuum bag film during the evacuating of the air from the interior space.

18. The method of claim 17, further comprising removing the composite part from the vacuum bagging system, wherein the embossed vacuum bag film self-releases from the composite part.
